(19) United States
(12) Patent Application Publication
(10) Pub. No.: US 2010/0097356 A1
(43) Pub. Date: Apr. 22, 2010

(54) INFORMATION PROCESSING APPARATUS AND INFORMATION PROCESSING METHOD

(75) Inventors: Hirohide MAENAKA, Tokyo (JP); Yuko TERAO, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/568,310

(22) Filed: Sep. 28, 2009

(30) Foreign Application Priority Data
Oct. 16, 2008 (JP) 2008-267894

(51) Int. Cl. G09G 5/00

(52) U.S. Cl. 345/204

(57) ABSTRACT

An information processing apparatus is provided which include a storage unit that stores at least one piece of associated information with which content data or content identification information and processing subject identification information used for identification of a processing subject, which is a device or an application enabled to perform processing on the content data, are associated, an input unit capable of accepting input of selection information to select the content data or the content identification information, and a display control unit that, when the input unit accepts input of selection information, acquires processing subject identification information associated with content data or content identification information selected by the selection information from the associated information stored in the storage unit and outputs the processing subject identification information to a display unit.

### BACKGROUND OF THE INVENTION

1. Field of the Invention

The present invention relates to an information processing apparatus and an information processing method.

2. Description of the Related Art

A technique of automatically setting and registering connected devices to be used has been disclosed (for example, see Japanese Patent Application Laid-Open No. 2007-036948). According to such a technique, there is no need for a user to perform a specific operation to determine a connected device to be used exclusively, leading to reduced time and effort to determine the connected device. However, it is difficult to grasp connected devices available for each piece of processing to be performed.

Moreover, if the user provides instructions to perform processing on content data by selecting the content data to be retained by an information processing apparatus and pressing a decision key, content data displayed in a portion of a display screen of the information processing apparatus may be switched to a full-screen display. However, in order to grasp applications or connected devices that can perform processing in any display other than the full-screen display, it is necessary for the user to activate an options menu so that the user can grasp applications or connected devices by viewing names of applications or connected devices displayed in the options menu. Therefore, it takes a time to activate the options menu.

Another technique is to display a submenu when the user selects content data and presses the decision key or the like.

### SUMMARY OF THE INVENTION

However, in order to grasp applications or connected devices that can perform processing in any display other than the full-screen display, there is an issue that it takes a time to activate the submenu. As a result, it is necessary for the user to activate the submenu so that the user can grasp applications or connected devices by viewing names of applications or connected devices displayed in the submenu.

The present invention has been made in view of the above issues and it is desirable to provide a novel and improved technique that enables the user to easily grasp applications or connected devices capable of performing processing on content data.

According to an Embodiment of the present invention, there is provided an information processing apparatus including a storage unit that stores at least one piece of associated information with which content data or content identification information and processing subject identification information used for identification of a processing subject, which is a device or an application enabled to perform processing on the content data, are associated, an input unit capable of accepting input of selection information to select the content data or the content identification information, and a display control unit that, when the input unit accepts input of selection information, acquires processing subject identification information associated with content data or content identification information selected by the selection information from the associated information stored in the storage unit and outputs the processing subject identification information to a display unit.

As described above, an information processing apparatus according to the present invention can provide a technique of enabling the user to easily grasp applications or connected devices capable of performing processing on content data.

### BRIEF DESCRIPTION OF THE DRAWINGS

FIG. 1 is a diagram showing the configuration of an information processing system according to a first embodiment of the present invention;

FIG. 2 is a diagram showing the configuration of an information processing apparatus according to the first embodiment of the present invention;

FIG. 3 is a diagram exemplifying the structure of associated information according to the first embodiment of the present invention;

FIG. 4 is a diagram exemplifying the structure of default information according to the first embodiment of the present invention;

FIG. 5 is a diagram exemplifying the structure of processing subject information according to the first embodiment of the present invention;

FIG. 6 is a diagram showing a screen example when a menu according to the first embodiment of the present invention is activated;

FIG. 7 is a diagram showing a screen example after the menu according to the first embodiment of the present invention is activated;

FIG. 8 is a diagram showing a screen example displayed for each state of a device according to the first embodiment of the present invention;

FIG. 9 is a diagram showing the flow of operation of the information processing apparatus according to the first embodiment of the present invention;

FIG. 10 is a diagram showing the configuration of the information processing system according to a second embodiment of the present invention;

FIG. 11 is a diagram showing the function configuration of the information processing apparatus according to the second embodiment of the present invention;

FIG. 12 is a diagram exemplifying the structure of associated information according to the second embodiment of the present invention

FIG. 13 is a diagram exemplifying the structure of default information according to the second embodiment of the present invention;

FIG. 14 is a diagram exemplifying the structure of processing subject information according to the second embodiment of the present invention;

FIG. 15 is a diagram showing a screen example after the menu according to the second embodiment of the present invention is activated;

FIG. 16 is a diagram showing the flow of operation of the information processing apparatus according to the second embodiment of the present invention.

### DETAILED DESCRIPTION OF EMBODIMENT

Hereinafter, preferred embodiments of the present invention will be described in detail with reference to the appended drawings. Note that, in the specification and the appended drawings, structural elements that have substantially the same function and structure are denoted with the same reference numerals, and repeated explanation of these structural elements is omitted. The description will be provided in the order shown below:

1. First embodiment

2. Second embodiment

### 1. First Embodiment

### Configuration of Information Processing System

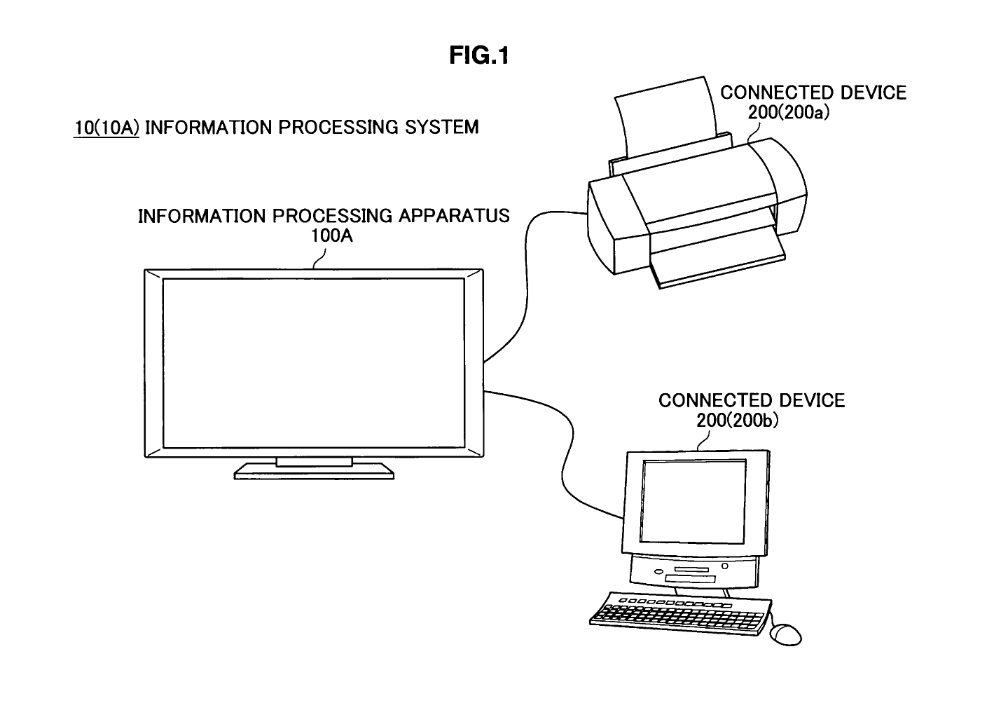

First, an information processing system according to a first embodiment of the present invention will be described. FIG. 1 is a diagram showing the configuration of an information processing system according to the first embodiment of the present invention. The information processing system according to the first embodiment of the present invention will be described below with reference to FIG. 1.

As shown in FIG. 1, an information processing system 10A according to the first embodiment of the present invention includes an information processing apparatus 100A and connected devices 200. The information processing system 10A shown in FIG. 1 is used to exchange data between the information processing apparatus 100A and the connected devices 200.

The information processing apparatus 100A and the connected devices 200 can be connected by a wire/wireless local area network (LAN), Bluetooth or the like. The information processing apparatus 100A and the connected devices 200 can also be connected by a universal serial bus (USB) cable, an IEEE1394 compliant cable, a high-definition multimedia interface (HDMI) cable or the like.

The information processing apparatus 100A is, for example, a digital broadcasting receiver that causes an application held by the local apparatus or the connected device 200 to perform processing on content data by storing the content data in the information processing apparatus 100A. In the present embodiment, a case in which a digital broadcasting receiver is used as an example of the information processing apparatus 100A will be described, but the information processing apparatus 100A is not specifically limited if the apparatus is capable of causing an application held by the local apparatus or the connected device 200 to perform processing on content data. The internal configuration of the information processing apparatus 100A will be described in detail later.

The connected device 200 performs processing on content data received from the information processing apparatus 100A based on, for example, a request from the information processing apparatus 100A. Here, a case in which a connected device 200a and a connected device 200b are used as the connected devices 200 will be described. The connected device 200a is a printer to print a still image on a sheet of paper when content data is still image information or the like, and the connected device 200b is a personal computer (PC) that saves content data in a storage device such as a hard disk held by the local apparatus. Here, a case in which the information processing system 10A includes two units of the connected device 200, but the number of the connected devices 200 is not specifically limited if the information processing system 10A includes at least one unit of the connected devices 200.

In the foregoing, the information processing system 10A according to the first embodiment of the present invention has been described. Next, the configuration of the information processing apparatus 100A according to the first embodiment of the present invention will be described.

[Configuration of Information Processing Apparatus]

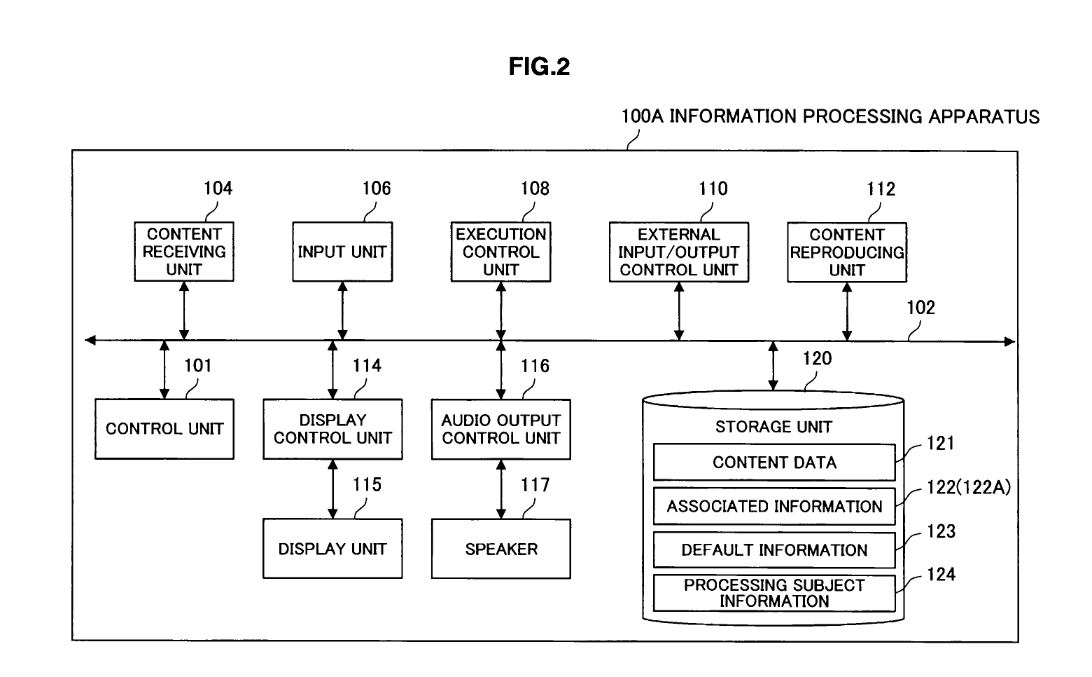

FIG. 2 is a diagram showing the configuration of an information processing apparatus according to the first embodiment of the present invention. The configuration of an information processing apparatus according to the first embodiment of the present invention will be described below with reference to FIG. 2.

As shown in FIG. 2, an information processing apparatus 100A includes a control unit 101, an internal bus 102, a content receiving unit 104, an input unit 106, an execution control unit 108, an external input/output control unit 110, a content reproducing unit 112, a display control unit 114, a display unit 115, an audio output control unit 116, a speaker 117, and a storage unit 120.

If content data received by the content receiving unit 104 is program content data, the control unit 101 converts the program content data into display images by the content reproducing unit 112 and the display control unit 114. Then, the control unit 101 exercises control so that the display images after conversion are displayed in the display unit 115. The control unit 101 also accepts a request signal received by the input unit 106 and exercises control so that another function unit is caused to perform processing depending on the request signal. The control unit 101 includes, for example, a central processing unit (CPU) and controls overall operations of the information processing apparatus 100A or a portion thereof following various programs recorded in a ROM, RAM, storage device, or removable recording medium.

The internal bus 102 is used to connect various function units in the information processing apparatus 100A to transmit data and the like among function units.

The content receiving unit 104 is used to receive content data via a receiving antenna or the like to send out the content data to the internal bus 102. If content data is program content data or the like, the content receiving unit 104 receives the program content data via, for example, a receiving antenna or an Internet Protocol (IP) network for video delivery and sends out the program content data to the internal bus 102.

The input unit 106 is used to receive an instruction signal transmitted from a controller operated by the user through infrared rays or the like. The received instruction signal is transmitted to the control unit 101 via the internal bus 102.

The execution control unit 108 is used to cause the connected device 200 to perform processing on content data indicated by instruction information input by the user via the input unit 106.

The external input/output control unit 110 is an interface to connect the information processing apparatus 100A and the connected device 200. The external input/output control unit 110 is an interface into which video information or audio information output from the connected device 200 are input and from which content data received by the information processing apparatus 100A is output to the connected device 200.

The content reproducing unit 112 performs processing to reproduce content data received by the content receiving unit 104. If content data received by the content receiving unit 104 is program content data, the content reproducing unit 112 performs processing to reproduce the program content data as video information. The content reproducing unit 112 separates packets of program content data received by the content receiving unit 104 through a video delivery IP network into signals of audio, video, data and the like and decodes each separated signal before outputting the signals to the display control unit 114 or the like. The content reproducing unit 112 can also reproduce content data 121 stored in the storage unit 120.

The display control unit 114 accepts video signal or data signal decoded by the content reproducing unit 112 or display data or the like stored in the storage unit 120 to generate display image information to be displayed in the display unit 115.

The display unit 115 is a display device that displays images such as program content data generated by the display control unit 114. Here, it is assumed that the display unit 115 is located inside the information processing apparatus 100A, but may be externally connected to the information processing apparatus 100A.

The audio output control unit 116 accepts an audio signal or the like decoded by the content reproducing unit 112 to generate audio information to be output to the speaker 117.

The speaker 117 is an output apparatus to output an audio and outputs audio information input via the audio output control unit 116.

The storage unit 120 includes a HDD (Hard Disk Drive) or the like and is used to store various icons and display data such as characters displayed in the display unit 115. In addition, the storage unit 120 stores the content data 121, associated information 122A, default information 123, processing subject information 124 and the like. The content data 121 is, for example, data such as program content, still image content, moving image content, and music content and the type thereof is not specifically limited. The associated information 122A, the default information 123, and the processing subject information 124 will be described in detail later.

In the foregoing, the configuration of the information processing apparatus 100A according to the first embodiment of the present invention has been described. Next, the structure of information stored in the storage unit 120 according to the first embodiment of the present invention will be described.

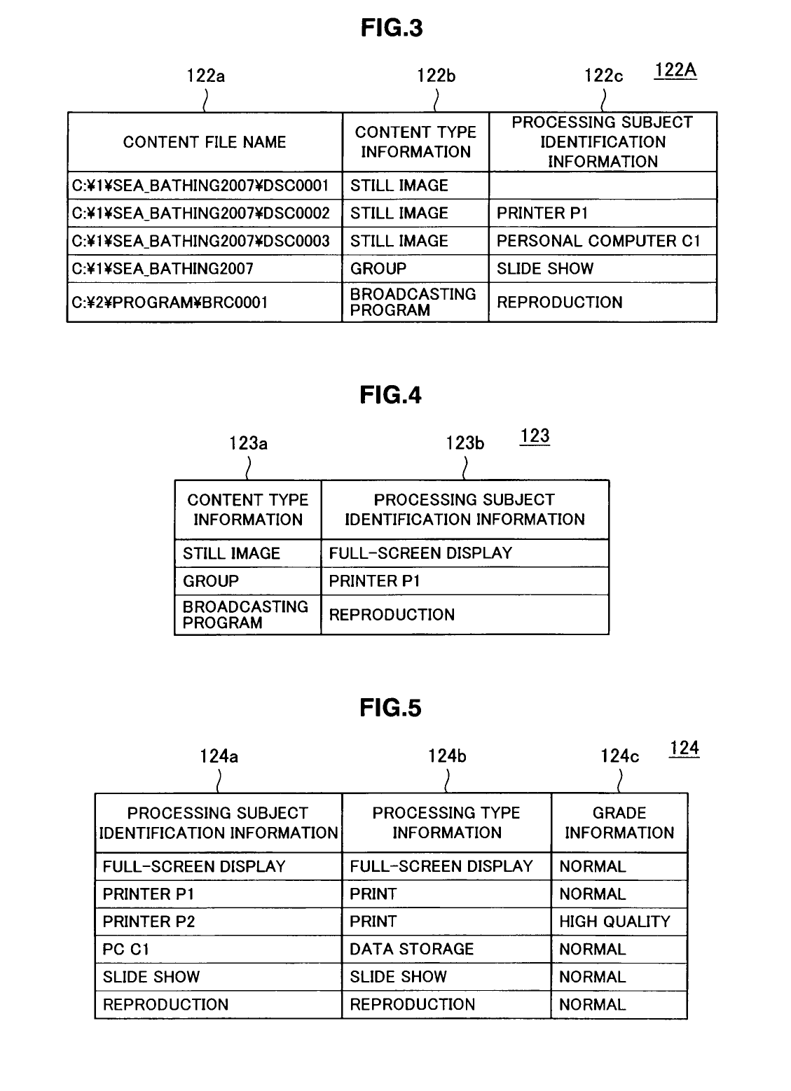

FIG. 3 is a diagram exemplifying the structure of associated information according to the first embodiment of the present invention. The structure of associated information according to the first embodiment of the present invention will be described below with reference to FIG. 3.

As shown in FIG. 3, the associated information 122A includes a content file name 122a, content type information 122b, and processing subject identification information 122c. The associated information 122A can be created by, for example, input into the input unit 106 by the user via a controller or the like.

The content file name 122a is used to indicate the location where content data is stored by an absolute path. The storage location of content data in the storage unit 120 can be identified by the content file name 122a. In the example shown in FIG. 3, it is clear that files whose file names are “ . . . sea_bathing_{—}2007¥DSC0001”, “ . . . sea_bathing_{—}2007¥DSC0002”, and “ . . . sea_bathing_{—}2007¥DSC0003” are located in the same folder, a “sea_bathing_{—}2007” folder.

The content type information 122b is information indicating types of content data. In the example shown in FIG. 3, it is clear that the content type information 122b of files whose file names are “ . . . DSC0001”, “ . . . DSC0002”, and “ . . . DSC0003” is “Still image” content. Also, it is clear that the content type information 122b of a file whose file name is “ . . . BRC0001” is a broadcasting program. The content type information 122b of a folder whose file name is “ . . . program¥BRC0001” is handled as a group. In addition, for example, “Moving image”, “Music” and the like are assumed as the content type information 122b. The content type information 122b can also be considered as an extension attached to the content file name 122a.

The processing subject identification information 122c is processing subject identification information used to identify a processing subject (such as an application and connected device) enabled to perform processing on content data. In the example shown in FIG. 3, the processing subject identification information 122c of a file whose file name is “ . . . DSC0002” is “Printer P1”. The processing subject identification information 122c of a file whose file name is “ . . . DSC0003” is “PC hard disk”. The processing subject identification information 122c of a folder whose file name is “ . . . sea_bathing_{—}2007” is “Slide show”. The processing subject identification information 122c of a file whose file name is “ . . . BRC0001” is “Reproduction”.

In the foregoing, the structure of associated information according to the first embodiment of the present invention has been described. Next, the structure of default information according to the first embodiment of the present invention will be described.

FIG. 4 is a diagram exemplifying the structure of default information according to the first embodiment of the present invention. The structure of default information according to the first embodiment of the present invention will be described with reference to FIG. 4. The default information 123 can be created by, for example, input into the input unit 106 by the user via a controller or the like. Or, the default information 123 may be preset in the information processing apparatus 100.

As shown in FIG. 4, the default information 123 includes content type information 123a, processing subject identification information 123b and the like. As shown in FIG. 4, the default processing subject identification information 123b corresponding to each piece of the content type information 123a is set in the default information 123.

In the foregoing, the structure of default information according to the first embodiment of the present invention has been described. Next, the structure of processing subject information according to the first embodiment of the present invention will be described.

FIG. 5 is a diagram exemplifying the structure of processing subject information according to the first embodiment of the present invention. The structure of processing subject information according to the first embodiment of the present invention will be described with reference to FIG. 5. The processing subject information 124 can be set, for example, by being acquired by the information processing apparatus 100A from a processing subject.

As shown in FIG. 5, the processing subject information 124 includes processing subject identification information 124a, processing type information 124b, and grade information 124c. As shown in FIG. 5, the processing type information 124b and the grade information 124c corresponding to each piece of the processing subject identification information 124a are set in the processing subject information 124. The processing subject identification information 124a is an item similar to the processing subject identification information 122c (see FIG. 3) and therefore, a detailed description thereof is omitted.

The processing type information 124b is information indicating the type of processing performed a processing subject identified by the processing subject identification information 124a. In the example shown in FIG. 5, for example, “Print” is set as the processing type information 124b corresponding to the processing subject identification information 124a “Printer P1” and “Printer P2”.

In the foregoing, the structure of processing subject information according to the first embodiment of the present invention has been described. Next, the function configuration of an information processing apparatus according to the first embodiment of the present invention will be described.

[Function Configuration of an Information Processing Apparatus]

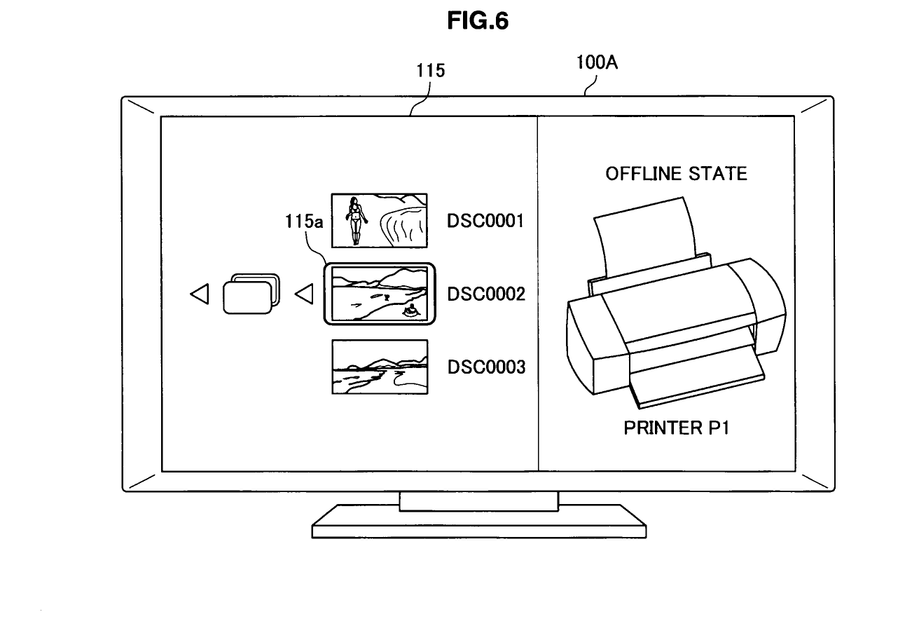

FIG. 6 is a diagram showing a screen example when a menu according to the first embodiment of the present invention is activated. Processing when the menu is activated by an information processing apparatus according to the first embodiment of the present invention will be described below with reference to FIG. 6 (see FIGS. 1 to 5 when appropriate).

When the user performs an operation to activate the menu by a controller or the like, the input unit 106 of the information processing apparatus 100A accepts input of menu activation instruction information instructing that the menu should be activated from the controller or the like. When the input unit 106 accepts input of menu activation instruction information, the display control unit 114 acquires data used for identification of the content data 121 from the storage unit 120 and outputs the data to the display unit 115. In the example shown in FIG. 6, files names “DSC0001”, “DSC0002”, and “DSC0003” of content data are displayed. Also, as shown in FIG. 6, the user can easily select content data by displaying the content data in the display unit 115 in thumbnail form. Here, three file names are displayed in the display unit 115, but the number of file names displayed in the display unit 115 is not specifically limited if at least one file name is displayed. Similarly, the number of pieces of content data displayed in the display unit 115 in thumbnail form is not specifically limited if at least one piece of content data is displayed.

Immediately after the user performs an operation to activate the menu by the controller or the like, a cursor 115a is displayed at a position specifying any one piece of content data displayed in the display unit 115. For example, the display control unit 114 considers that the input unit 106 has accepted input of selection information to select the top content data (file name “DSC0001”) and displays the cursor 115a so as to surround the top content data displayed in the display unit 115.

Assume that, after an operation to activate the menu by the controller or the like being performed, the user performs an operation to move the cursor 115a downward. In such a case, the input unit 106 accepts input of selection information to select the second content data (file name “DSC0002”) from above. The display control unit 114 acquires the processing subject identification information 122c associated with the content data (file name “DSC0002”) selected by the user from the associated information 122A stored in the storage unit 120 to output the processing subject identification information 122c to the display unit 115. In the example shown in FIG. 3, the processing subject identification information 122c “Printer P1” associated with the content file name (file name “ . . . DSC0002”) is acquired to output “Printer P1” to the display unit 115 (see FIG. 6). If a plurality of pieces of the processing subject identification information 122c associated with content data is present, the plurality of pieces of the processing subject identification information 122c may be output to the display unit 115. Or, as shown in FIG. 6, image information (printer image information) associated with “Printer P1” may be acquired from the storage unit 120 to output the image information to the display unit 115 (see FIG. 6).

The display control unit 114 may inspect the state of a processing subject identified by the processing subject identification information output to the display unit 115 to further output the state information obtained by inspection to the display unit 115. If “Printer P1” inspected by the display control unit 114 is in an offline state, the display control unit 114 outputs the state information “Offline state” to the display unit 115 (see FIG. 6). In this manner, the user can know the degree of congestion of applications or connected states of devices before the user makes a decision by selecting content data from the menu. When being output to the display unit 115 associated with “Printer P1”, the display control unit 114 may acquire color information corresponding to the state of “Printer P1” from the storage unit 120 to output image information with a tinge of the color indicated by the acquired color information to the display unit 115. If in an “offline” state, for example, image information with a tinge of dark gray may be output to the display unit 115.

If the display control unit 114 determines that state information indicates a state in which it is difficult to perform processing by a processing subject, processing to output the processing subject identification information 122c and the state information to the display unit 115 may be omitted. Then, the display control unit 114 determines whether the storage unit 120 stores the other processing subject information 124 containing the same processing type information 124b as the processing type information 124b associated with the processing subject identification information. If the display control unit 114 determines that the storage unit 120 stores the other processing subject information 124, the display control unit 114 inspects the state of the processing subject identified by the processing subject identification information 124a contained in the processing subject information 124. The display control unit 114 determines whether the state information obtained by inspection indicates a state in which processing by the processing subject can be performed. When the display control unit 114 determines that the state information indicates a state in which processing by the processing subject can be performed, the display control unit 114 outputs the processing subject identification information 124a and the state information to the display unit 115.

In this manner, if the state of the processing subject indicated by the processing subject identification information 122c associated with content data selected by the user is not good, the processing subject identification information 124a of a processing subject capable of performing the processing in place thereof can be output to the display unit 115. Assume, for example, that the state of “Printer P1” of the processing subject identification information 122c associated with the content data (file name “DSC0002”) selected by the user is not good. In such a case, the processing subject information 124 (the processing subject identification information 124a “Printer P2”) containing the same processing type information 124b “Print” as that associated with “Printer P1” is present. Thus, the display control unit 114 inspects the state of “Printer P2” and, if the state thereof is good, outputs “Printer P2” to the display unit 115.

The display control unit 114 may acquire grade information by determining the grade of content data. In such a case, the display control unit 114 acquires grade information 124c associated with the processing subject identification information 122c that is acquired from the associated information 122A from the processing subject information 124. The display control unit 114 determines whether the acquired grade information 124c contains grade information acquired based on determination of content data. If the display control unit 114 determines that the grade information 124c does not contain such grade information, the display control unit 114 omits processing to output the processing subject identification information 122c and the state information to the display unit 115. Then, the display control unit 114 determines whether the storage unit 120 stores the processing subject information 124 that contains the same processing type information 124b as that associated with the processing subject identification information 122c and whose grade information 124c contains grade information acquired based on determination of content data. If the display control unit 114 determines that the storage unit 120 stores the processing subject information 124 that satisfies the above conditions, the display control unit 114 outputs the processing subject identification information 124a of the processing subject information 124 to the display unit 115.

In this manner, if the processing subject indicated by the processing subject identification information 122c associated with content data selected by the user is not compatible with the grade of the content data, the compatible processing subject identification information 124a in place thereof can be output to the display unit 115. Assume, for example, that the grade of the content data (file name “DSC0002”) selected by the user is high quality. In such a case, the grade information 124c associated with “Printer P1” is “Normal” and thus, “Printer P1” is not compatible with high-quality content data. In this case, the processing subject information 124 (the processing subject identification information 124a “Printer P2”) containing the same processing type information 124b “Print” as that associated with “Printer P1” is present. Thus, the display control unit 114 acquires the grade information 124c associated with “Printer P2” and outputs “Printer P2” compatible with high-quality content data to the display unit 115 because the grade information 124c thereof is “high quality”.

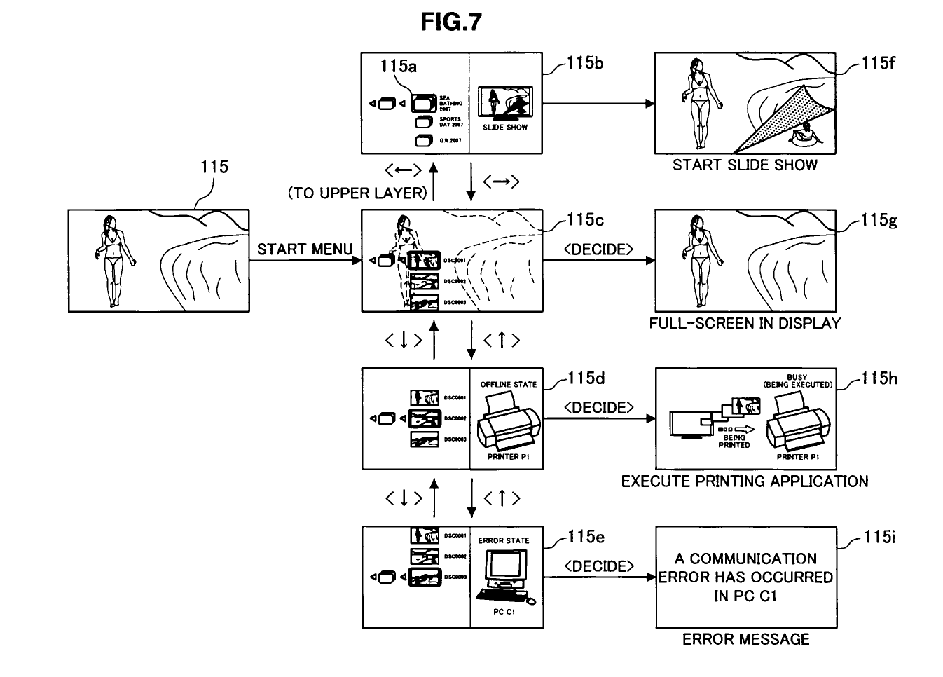

FIG. 7 is a diagram showing a screen example after the menu according to the first embodiment of the present invention is activated. Processing after the menu according to the first embodiment of the present invention is activated will be described with reference to FIG. 7 (see FIGS. 1 to 5 when appropriate).

As shown in FIG. 7, after the menu is activated, the input unit 106 of the information processing apparatus 100A can accept input of cursor movement instruction information to instruct that the cursor 115a should be moved from the controller or the like. After the input unit 106 accepts input of cursor movement instruction information, the display control unit 114 moves the cursor 115a according to the instructions.

Here, if the content data (file name “DSC0001”) is selected, the display control unit 114 attempts to acquire the processing subject identification information 122c associated with the content data from the associated information 122A. However, the processing subject identification information 122c is not set. Thus, the display control unit 114 acquires the content type information 122b “Still image” corresponding to the content data (file name “DSC0001”). The display control unit 114 acquires the processing subject identification information 123b “full-screen display” corresponding to the content type information 123a “Still image” from the default information 123. The display control unit 114 makes a full-screen display of the content data (file name “DSC0001”) (see a display unit 115c in FIG. 7).

Assume that the user presses the decision key while the top content data (file name “DSC0001”) is selected by the controller or the like. The input unit 106 accepts input of execution information instructing that processing on the selected content data (file name “DSC0001”) should be performed. When the input unit 106 accepts input of the execution information, the execution control unit 108 causes the processing subject identified by the processing subject identification information 122c acquired from the associated information 122A to perform processing on the content data. Here, the execution control unit 108 causes an application that carries out a full-screen display to perform full-screen display processing on the content data (see a display unit 115g in FIG. 7).

When a folder (file name “sea_bathing2007”) is selected, the display control unit 114 acquires the processing subject identification information 122c “Slide show” associated with the folder from the associated information 122A. The display control unit 114 displays “Slide show” in the display unit 115 (see a display unit 115b in FIG. 7).

Assume that the user presses the decision key while the folder (file name “sea_bathing2007”) is selected by the controller or the like. The input unit 106 accepts input of execution information instructing that processing on the selected folder (file name “sea_bathing2007”) should be performed. When the input unit 106 accepts input of the execution information, the execution control unit 108 causes the processing subject identified by the processing subject identification information 122c acquired from the associated information 122A to perform processing on the folder. Here, the execution control unit 108 causes an application that carries out a slide show to carry out a slide show for the folder (see a display unit 115f in FIG. 7). Assume that, for example, content data to be displayed in a slide show is content data (file names “DSC0001”, “DSC0002”, and “DSC0003”) present immediately below the folder (file name “sea_bathing2007”).

If the content data (file name “DSC0002”) is selected, as has been described with reference to FIG. 6, the processing subject identification information 122c “Printer P1” associated with the content file name “ . . . DSC0002” is output to the display unit 115 (see a display unit 115d in FIG. 7).

Assume that the user presses the decision key while the second content data from above (file name “DSC0002”) is selected by the controller or the like. The input unit 106 accepts input of execution information instructing that processing on the selected content data (file name “DSC0002”) should be performed. When the input unit 106 accepts input of the execution information, the execution control unit 108 causes the processing subject identified by the processing subject identification information 122c “Printer P1” acquired from the associated information 122A to perform processing on the content data. Here, the execution control unit 108 causes the printer P1 to perform printing processing on content data (see a display unit 115h in FIG. 7).

If the content data (file name “DSC0003”) is selected, the display control unit 114 acquires the processing subject identification information 122c “PC C1” associated with the content data from the associated information 122A and outputs “PC C1” to the display unit 115 (see a display unit 115d in FIG. 7). The display control unit 114 makes a full-screen display of the content data (file name “DSC0003”) (see a display unit 115e in FIG. 7). In the example shown in FIG. 7, image information (PC image information) associated with “PC C1” is acquired from the storage unit 120 and outputs the image information to the display unit 115.

If the inspected “PC C1” is in an error state (for example, a communication error state), the display control unit 114 the state information “Error state” is output to the display unit 115 (see a display unit 115e in FIG. 7).

Assume that the user presses the decision key while the third content data from above (file name “DSC0003”) is selected by the controller or the like. The input unit 106 accepts input of execution information instructing that processing on the selected content data (file name “DSC0003”) should be performed. When the input unit 106 accepts input of the execution information, the execution control unit 108 causes the processing subject identified by the processing subject identification information 122c acquired from the associated information 122A to perform processing on the content data. Here, the execution control unit 108 attempts to cause the PC C1 to perform save processing of content data, but because the PC C1 is in an error state, the save processing of content data is not performed and, for example, an error message is output to the display unit 115 (see a display unit 115i in FIG. 7).

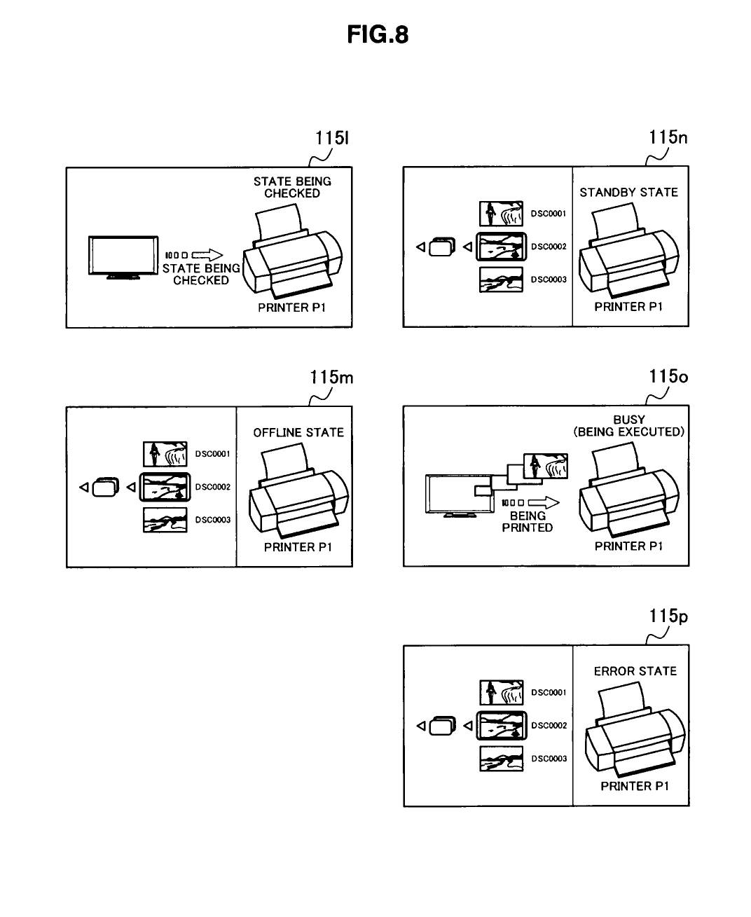

FIG. 8 is a diagram showing a screen example displayed for each state of a device according to the first embodiment of the present invention. A screen example displayed for each state of a device according to the first embodiment of the present invention will be described below with reference to FIG. 8.

As shown in FIG. 8, a display unit 115l is displayed while the display control unit 114 performs processing to acquire state information from “Printer P1”. In the display unit 115l, for example, a message “State being checked” may be displayed. The display control unit 114 may change the color of an image of a printer displayed while “State being checked” is displayed, for example, to white.

As has been described with reference to FIG. 6, a display unit 115m is displayed when the display control unit 114 acquires state information from “Printer P1” and the state is “Offline state”.

A display unit 115n is displayed when the display control unit 114 acquires state information from “Printer P1” and the state is “Standby state”. In the display unit 115n, for example, a message “Standby state” may be displayed. The display control unit 114 may change the color of an image of a printer displayed while “Standby state” is displayed, for example, to light blue.

A display unit 115o is displayed when the display control unit 114 acquires state information from “Printer P1” and the state is “Busy state (being executed)”. In the display unit 115o, for example, a message “Busy state (being executed)” may be displayed. The display control unit 114 may change the color of an image of a printer displayed while “Busy state (being executed)” is displayed, for example, to light gray.

A display unit 115p is displayed when the display control unit 114 acquires state information from “Printer P1” and the state is “Error state”. In the display unit 115p, for example, a message “Error state” may be displayed. The display control unit 114 may change the color of an image of a printer displayed while “Error state” is displayed, for example, to red.

In the foregoing, the function configuration of an information processing apparatus according to the first embodiment of the present invention has been described. Next, operations of an information processing apparatus according to the first embodiment of the present invention will be described.

[Operations of an Information Processing Apparatus]

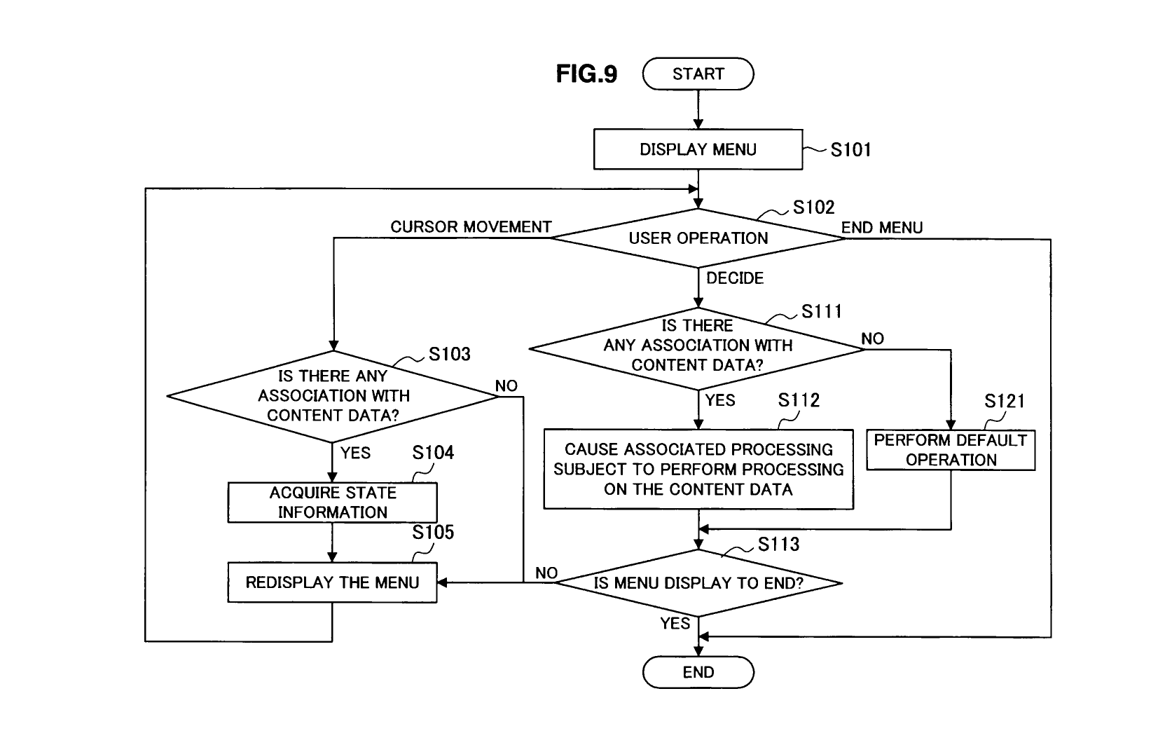

FIG. 9 is a diagram showing the flow of operation of the information processing apparatus according to the first embodiment of the present invention. Operations of an information processing apparatus according to the first embodiment of the present invention will be described below with reference to FIG. 9 (see FIGS. 1 to 5 when appropriate).

When the user performs an operation to activate the menu using the controller or the like, the input unit 106 of the information processing apparatus 100A accepts input of menu activation instruction information instructing that the menu should be activated from the controller or the like. When the input unit 106 accepts input of the menu activation instruction information, the display control unit 114 acquires data used for identification of the content data 121 from the storage unit 120 to output the data to the display unit 115 and displays a menu (step S101).

The input unit 106 accepts input of a user operation. Subsequently, the display control unit 114 determines the user operation (step S102). If the display control unit 114 determines that the user operation is a cursor movement (“Cursor movement” at step S102), the display control unit 114 determines whether there is any association with content data specified by the cursor after being moved (step S103). If the display control unit 114 determines that there is any association with content data (“YES” at step S103), the display control unit 114 acquires state information of a processing subject associated with the content data (step S104). The display control unit 114 outputs the acquired state information to the display unit 115 and redisplays the menu before returning to step S102. If the display control unit 114 determines that there is no association with content data (“NO” at step S103), the display control unit 114 redisplays the menu (step S105) before returning to step S102.

If the display control unit 114 determines that the user operation is a decision (“Decision” at step S102), the execution control unit 108 determines whether there is any association with content data specified by the cursor (step S111). If the execution control unit 108 determines that there is any association with content data (“YES” at step S111), the execution control unit 108 causes a processing subject associated with the content data to perform processing on the content data (step S112) before continuing to step S113. If the execution control unit 108 determines that there is no association with content data (“NO” at step S111), the execution control unit 108 performs a default operation to cause the default processing subject to perform processing on the content data (step S121) before continuing to step S113. At step S113, the execution control unit 108 determines whether processing caused to be performed is to end the menu display. If the processing is not to end the menu display (“NO” at step S113), the execution control unit 108 redisplays the menu (step S105) before returning to step S102. If the processing caused to be performed is to end the menu display (“YES” at step S113), the execution control unit 108 terminates processing. If, for example, processing caused to be performed is a full-screen display or the like, the processing is determined to end the menu display.

Subsequently, a second embodiment will be described.

### 2. Second Embodiment

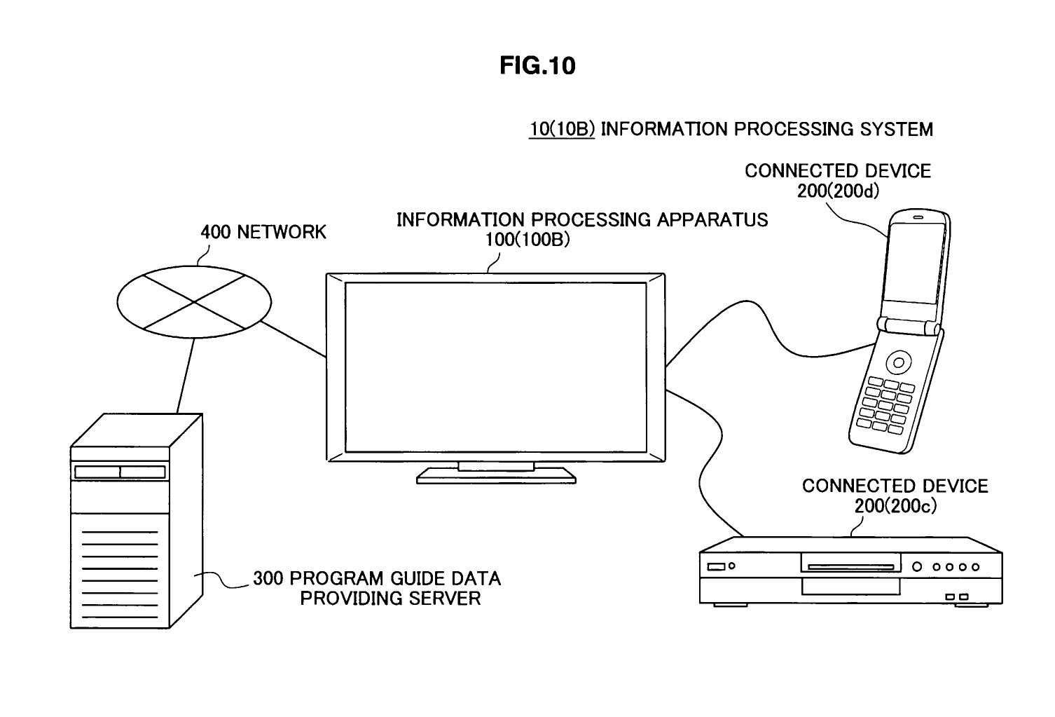

The second embodiment is different from the first embodiment in the configuration of an information processing system. Therefore, the configuration of an information processing system according to the second embodiment will be described with reference to FIG. 10.

FIG. 10 is a diagram showing the configuration of an information processing system according to the second embodiment of the present invention. An information processing system according to the second embodiment of the present invention will be described with reference to FIG. 10.

As shown in FIG. 10, an information processing system 10B according to the second embodiment of the present invention includes, similar to the information processing system 10A according to the first embodiment of the present invention, an information processing apparatus 100A and connected devices 200. However, the information processing system 10B according to the second embodiment of the present invention is provided with the connected device 200 capable of making settings to record program content data as the connected device 200. The connected device 200 is, for example, a recorder (connected device 200c) capable of recording program content, a mobile device (connected device 200d) or the like. Data can be exchanged between an information processing apparatus 100B and the connected device 200.

The information processing apparatus 100B and the connected device 200 can be connected by, for example, a wire/wireless LAN (Local Area Network), Bluetooth or the like. The information processing apparatus 100B and the connected device 200 can also be connected by a USB (Universal Serial Bus) cable, a cable compliant with IEEE1394, a HDMI (High-Definition Multimedia Interface) cable or the like.

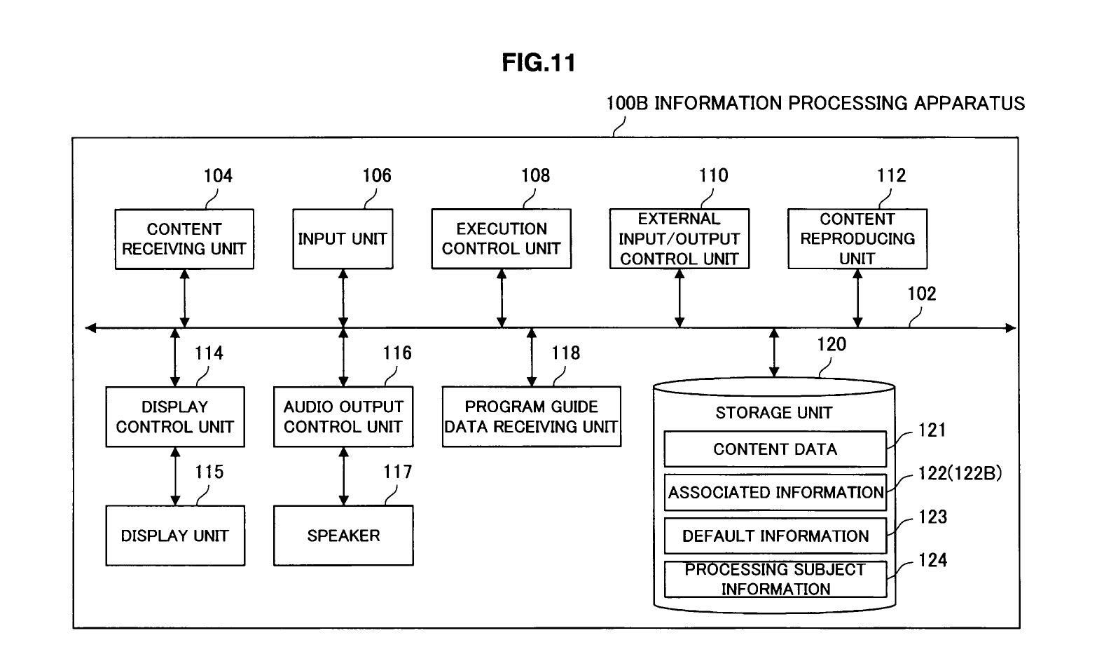

The information processing system 10B further includes a program guide data providing server 300. The program guide data providing server 300 is made ready for communication with the information processing apparatus 100B via a network 400 so that program guide data can be provided to the information processing apparatus 100B. If the storage unit 120 of the information processing apparatus 100B already stores program guide data, the program guide data providing server 300 and the network 400 may not be present. Or, the content receiving unit 104 (see FIG. 11) may receive program guide data, in addition to program content data and, in that case, the program guide data providing server 300 and the network 400 may not be present.

In the foregoing, the information processing system 10B according to the second embodiment of the present invention has been described. Next, the configuration of the information processing apparatus 100B according to the second embodiment of the present invention will be described.

[Configuration of Information Processing Apparatus]

FIG. 11 is a diagram showing the function configuration of the information processing apparatus according to the second embodiment of the present invention. As shown in FIG. 11, the information processing apparatus 100B according to the second embodiment of the present invention is different from the information processing apparatus 100A according to the first embodiment in that a program guide data receiving unit 118 is added. Also, the associated information 122A is replaced by associated information 122B.

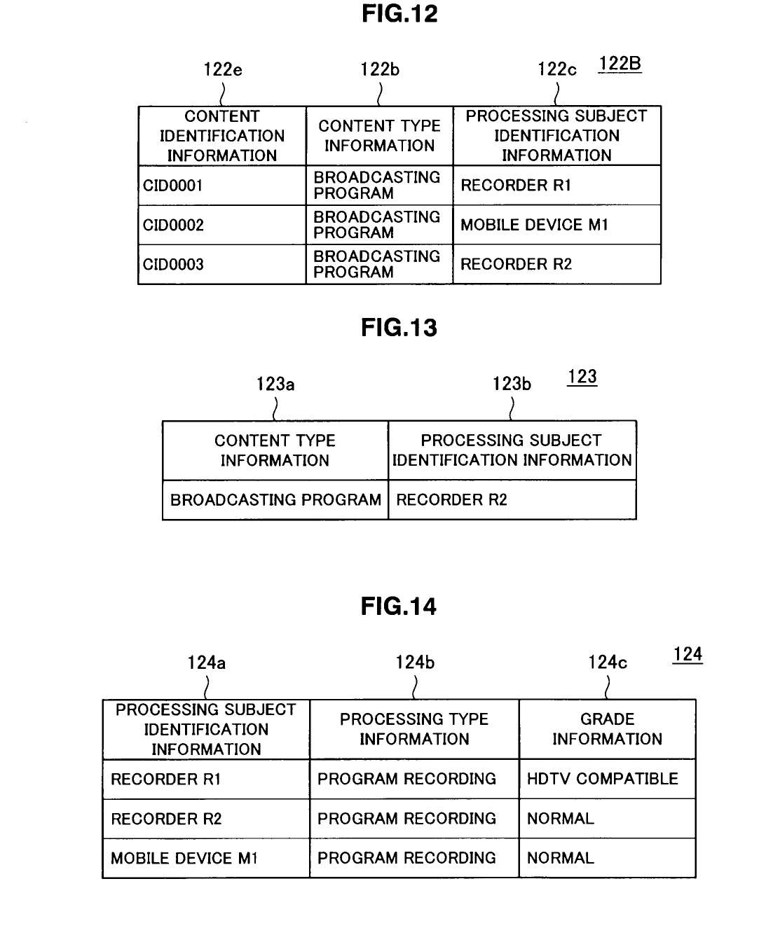

FIG. 12 is a diagram exemplifying the structure of associated information according to the second embodiment of the present invention. The structure of associated information according to the second embodiment of the present invention will be described with reference to FIG. 12.

As shown in FIG. 12, the associated information 122B includes content identification information 122e, the content type information 122b, the processing subject identification information 122c and the like. The associated information 122B can be created by, for example, input into the input unit 106 by the user via the controller or the like. The content type information 122b and the processing subject identification information 122c have been described with reference to FIG. 3 and thus, a description thereof is omitted.

The content identification information 122e is used to identify program content data. Program content data received by the program guide data receiving unit 118 can be determined by the content identification information 122e. In the example shown in FIG. 12, it is clear that the content type information 122b “Broadcasting program” and the processing subject identification information 122c “Recorder R1” are associated with the content identification information 122e “CID0001”. Similarly, it is clear that the content type information 122b “Broadcasting program” and the processing subject identification information 122c “Mobile device M1” are associated with the content identification information 122e “CID0002”.

In the foregoing, the structure of associated information according to the second embodiment of the present invention has been described. Next, the structure of default information according to the second embodiment of the present invention will be described.

FIG. 13 is a diagram exemplifying the structure of default information according to the second embodiment of the present invention. The structure of default information according to the second embodiment of the present invention will be described with reference to FIG. 13. The default information 123 can be created by, for example, input into the input unit 106 by the user via the controller or the like. Or, the default information 123 may be set in advance in the information processing apparatus 100.

As shown in FIG. 13, the default information 123 includes the content type information 123a, the processing subject identification information 123b and the like. As shown in FIG. 13, the default processing subject identification information 123b corresponding to each piece of the content type information 123a is set in the default information 123. The content type information 123a and the processing subject identification information 123b have been described with reference to FIG. 4 and thus, a description thereof is omitted.

In the foregoing, the structure of default information according to the second embodiment of the present invention has been described. Next, the structure of processing subject information according to the second embodiment of the present invention will be described.

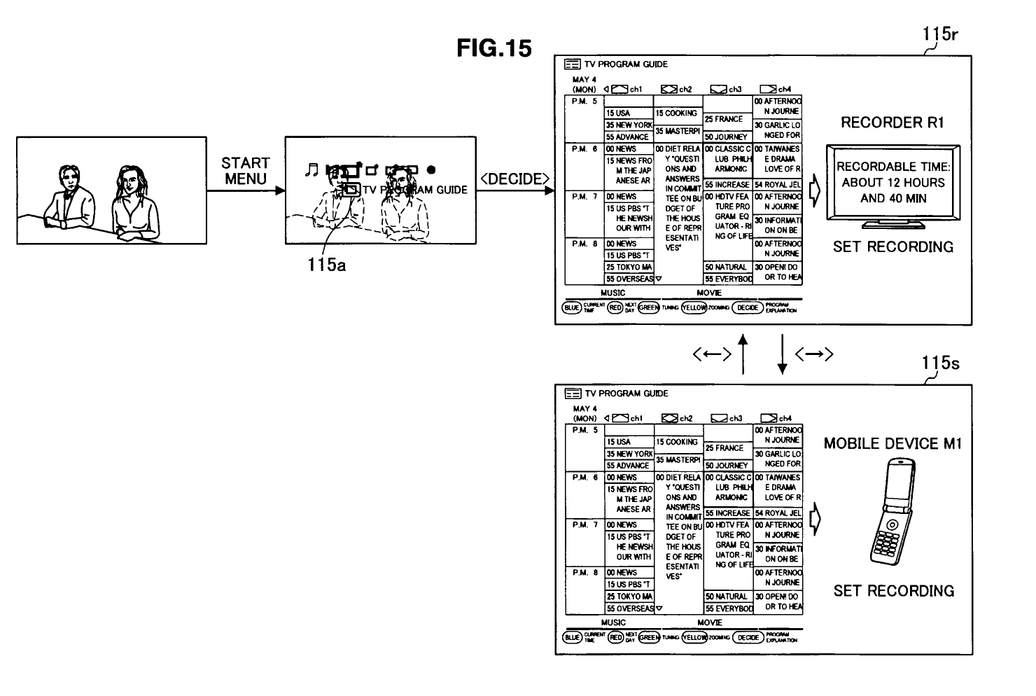

FIG. 14 is a diagram exemplifying the structure of processing subject information according to the second embodiment of the present invention. The structure of processing subject information according to the second embodiment of the present invention will be described with reference to FIG. 14. The processing subject information 124 may be set, for example, after being acquired from a processing subject by the information processing apparatus 100B.

As shown in FIG. 14, the processing subject information 124 includes the processing subject identification information 124a, the processing type information 124b, and the grade information 124c. As shown in FIG. 14, the processing type information 124b and the grade information 124c corresponding to each piece of the processing subject identification information 124a are set in the processing subject information 124. The processing subject identification information 124a, the processing type information 124b, and the grade information 124c have been described with reference to FIG. 6 and thus, a description thereof is omitted.

FIG. 15 is a diagram showing a screen example after the menu according to the second embodiment of the present invention is activated. Processing after the menu according to the first embodiment of the present invention is activated will be described with reference to FIG. 15 (see FIGS. 10 to 14 when appropriate).

As shown in FIG. 15, after the menu is activated, the input unit 106 of the information processing apparatus 100B can accept input of cursor movement instruction information to instruct that the cursor 115a should be moved from the controller or the like. After the input unit 106 accepts input of cursor movement instruction information, the display control unit 114 moves the cursor 115a according to the instructions.

Here, when “TV program guide” is selected and the decision key is pressed, the display control unit 114 displays program guide data received by the content receiving unit 104 in the display unit 115.

When the program (program name “Classic club . . . ”) is selected, the display control unit 114 acquires the processing subject identification information 122c “Recorder R1” associated with the content identification information from the associated information 122A and outputs “Recorder R1” to the display unit 115 (see a display unit 115r in FIG. 8). In addition to the output of “Recorder R1” to the display unit 115, the display control unit 114 may acquire the recordable time “about 12 hours and 40 min” of the recorder R1 from the recorder R1 to output the recordable time to the display unit 115.

When the program (program name “Taiwanese drama . . . ”) is selected, the display control unit 114 acquires the processing subject identification information 122c “Mobile device M1” associated with the content identification information from the associated information 122A and outputs “Mobile device M1” to the display unit 115 (see a display unit 115s in FIG. 8).

Here, it is assumed that content identification information of each program and the processing subject identification information 122c are associated, but the entire program guide and the processing subject identification information 122c may be associated. Or, the processing subject identification information 122c may be associated in units of serials of program.

Assume that the user presses the decision key while the program (program name “Classic club . . . ”) is selected by the controller or the like. The input unit 106 accepts input of execution information instructing that processing on the selected content identification information (program name “Classic club . . . ”) should be performed. When the input unit 106 accepts input of the execution information, the execution control unit 108 causes the processing subject identified by the processing subject identification information 122c acquired from the associated information 122 to perform processing on the content data. Here, the execution control unit 108 causes the recorder R1 to perform set recording processing of the program content data (see the display unit 115r in FIG. 8).

Assume that the user presses the decision key while the program (program name “Taiwanese drama . . . ”) is selected by the controller or the like. The input unit 106 accepts input of execution information instructing that processing on the selected content identification information (program name “Taiwanese drama . . . ”) should be performed. When the input unit 106 accepts input of the execution information, the execution control unit 108 causes the processing subject identified by the processing subject identification information 122c acquired from the associated information 122 to perform processing on the content data. Here, the execution control unit 108 causes the mobile device M1 to perform set recording processing of the program content data (see the display unit 115s in FIG. 8).

Assume that processing on content data corresponds to storage (such as recording) of program content data. In such a case, after the input unit 106 accepts input of execution information, if the execution control unit 108 determines that the processing subject identified by the processing subject identification information 122c acquired from the associated information 122 is a mobile device, the execution control unit 108 inspects the state of the mobile device. The execution control unit 108 determines whether the state information obtained by inspection indicates that it is possible to store program content data in the mobile device.

If the execution control unit 108 determines that the state information does not indicate that it is possible to store program content data in the mobile device, the execution control unit 108 causes the storage unit 120 to store the program content data by temporarily putting storage of the program content data by the mobile device on hold. The execution control unit 108 reinspects the state of the mobile device to determine whether the state information obtained by inspection indicates that it is possible to store program content data in the mobile device. If the execution control unit 108 determines that the state information indicates that it is possible to store program content data in the mobile device, the execution control unit 108 transfers program content data stored in the storage unit 120 to the mobile device to be stored therein.

According to the above mechanism, if a mobile device is not connected during recording (such as set recordings), program content data is temporarily stored in the storage unit 120 (built-in storage device) so that, when the mobile device is connected, the program content data can be stored in the mobile device. Accordingly, program content data can be recorded in the mobile device in a pseudo fashion. For example, news program content data of every night can easily be carried in a mobile device (such as a mobile phone) when commuting to offices on the next morning. In this case, the mobile device is not connected when program content data is recorded and thus, the program content data is temporarily recorded in the storage unit 120 so that when the mobile device is connected, the program content data can be sent to the mobile device.

As described in the first embodiment, the display control unit 114 may acquire grade information by determining the grade of content data. Accordingly, if a processing subject indicated by the processing subject identification information 122c associated with the content data selected by the user is not compatible with the grade of the content data, the compatible processing subject identification information 124a can be output to the display unit 115 in place thereof.

Assume, for example, that the grade of program content data selected by the user (the content identification information 122e “CID0003” and program name “HDTV feature program . . . ”) is a HDTV program. In such a case, the grade information 124c associated with the processing subject identification information 122c “Recorder R2” associated with the content identification information 122e “CID0003” is “Normal”. That is, if the program content data (the content identification information 122e “CID0003”) is recorded by the recorder R2, the program content data will be recorded as SD image information. In this case, the processing subject information 124 (the processing subject identification information 124a “Recorder R1”) containing the same processing type information 124b “Set program” as the processing type information 124b “Set program” associated with “Recorder R2” is present. Thus, the display control unit 114 acquires the grade information 124c associated with “Recorder R1” and outputs “Recorder R1” compatible with content data of HDTV programs to the display unit 115 because the grade information 124c thereof is “HDTV compatible”.

In the foregoing, the function configuration of an information processing apparatus according to the second embodiment of the present invention has been described. Next, operations of an information processing apparatus according to the second embodiment of the present invention will be described.

[Operations of an Information Processing Apparatus]

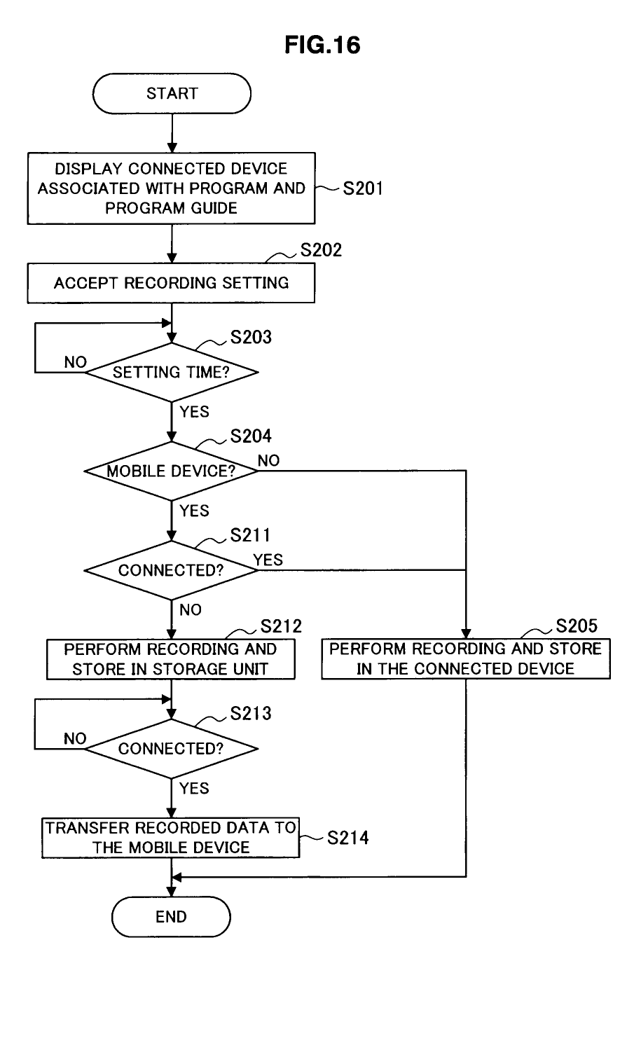

FIG. 16 is a diagram showing the flow of operation of the information processing apparatus according to the second embodiment of the present invention. Operations of an information processing apparatus according to the second embodiment of the present invention will be described below with reference to FIG. 16 (see FIGS. 10 to 14 when appropriate).

When the user performs an operation to activate the program guide using the controller or the like, the input unit 106 of the information processing apparatus 100B accepts input of program guide activation instruction information instructing that the program guide should be activated from the controller or the like. When the input unit 106 accepts input of the program guide activation instruction information, the display control unit 114 outputs the program guide received by the content receiving unit 104 and connected devices associated with programs to the display unit 115 (step S201).

When the user performs an operation to make a recording setting of a program using the controller or the like, the input unit 106 accepts input of recording setting instruction information to make a recording setting from the controller or the like (step S202). Subsequently, the execution control unit 108 determines whether the current time has reached the setting time and if the execution control unit 108 determines that the setting time has not yet arrived (“NO” at step S203), the execution control unit 108 returns to step S203. If the execution control unit 108 determines that the setting time has arrived (“YES” at step S203), the execution control unit 108 determines whether a connected device associated with the program is a mobile device (step S204). If the execution control unit 108 determines that the connected device associated with the program is not a mobile device (“NO” at step S204), the execution control unit 108 performs recording by the connected device and stores program content data obtained by recording in the connected device (step S205) before terminating processing.

If the execution control unit 108 determines that the connected device associated with the program is a mobile device (“YES” at step S204), the execution control unit 108 determines whether the mobile device is connected (step S211). If the control unit 108 determines that the mobile device is connected (“YES” at step S211), the execution control unit 108 performs recording by the connected device and stores program content data obtained by recording in the connected device (step S205) before terminating processing. If the control unit 108 determines that the mobile device is not connected (“NO” at step S211), the execution control unit 108 performs recording and stores program content data obtained by recording in the storage unit 120 (step S212). The execution control unit 108 determines again whether the mobile device is connected (step S213). If the execution control unit 108 determines that the mobile device is not connected (“NO” at step S213), the control unit 108 returns to step S213. If the execution control unit 108 determines that the mobile device is connected (“YES” at step S213), the control unit 108 transfers recorded data (program content data obtained by recording) to the mobile device (step S214) before terminating processing.

Timing to perform processing at step S213 is not specifically limited. Processing at step S213 can be performed, for example, when another program is recorded by the mobile device next time or when it becomes necessary to perform communication between the information processing apparatus 100B and the mobile device by some kind of processing.

It should be understood by those skilled in the art that various modifications, combinations, sub-combinations and alterations may occur depending on design requirements and other factors insofar as they are within the scope of the appended claims or the equivalents thereof.

The present application contains subject matter related to that disclosed in Japanese Priority Patent Application JP 2008-267894 filed in the Japan Patent Office on Oct. 16, 2008, the entire content of which is hereby incorporated by reference.

What is claimed is:

1. An information processing apparatus, comprising:
a storage unit that stores at least one piece of associated information with which content data or content identification information and processing subject identification information used for identification of a processing subject, which is a device or an application enabled to perform processing on the content data, are associated;
an input unit capable of accepting input of selection information to select the content data or the content identification information; and
a display control unit that, when the input unit accepts input of selection information, acquires processing subject identification information associated with content data or content identification information selected by the selection information from the associated information stored in the storage unit and outputs the processing subject identification information to a display unit.

2. The information processing apparatus according to claim 1, wherein
the display control unit that inspects a state of the processing subject identified by the processing subject identification information output to the display unit and further outputs state information obtained by the inspection to the display unit.

3. The information processing apparatus according to claim 2, wherein
the storage unit that further stores processing subject information with which processing subject identification information and processing type information indicating a type of processing are associated and
the display control unit that determines whether the state information obtained by the inspection indicates a state in which it is possible to perform processing by the processing subject and if it is determined that the state information indicates a state that does not allow execution of processing by the processing subject, determines whether the storage unit stores other processing subject information containing same processing type information as processing type information associated with the processing subject identification information by omitting processing to output the processing subject identification information and the state information to the display unit and if it is determined that the storage unit stores other processing subject information, inspects the state of the processing subject identified by processing subject identification information contained in the processing subject information to determine whether the state information obtained by the inspection indicates a state that allows execution of processing by the processing subject and if it is determined that the state information indicates a state that allows execution of processing by the processing subject, outputs the processing subject identification information and the state information to the display unit.

4. The information processing apparatus according to claim 1, wherein
the storage unit that further stores processing subject information with which processing subject identification information, processing type information indicating a type of processing, and grade information indicating a grade of executable processing are associated and
the display control unit that acquires first grade information by determining the grade of the content data and also acquires second grade information associated with the processing subject identification information acquired from the associated information stored in the storage unit from the processing subject information, determines whether the second grade information contains the first grade information and if it is determined that the second grade information does not contain the first grade information, determines whether the storage unit stores processing subject information that contains same processing type information as processing type information associated with the processing subject identification information and whose grade information contains the first grade information by omitting processing to output the processing subject identification information and the state information to the display unit and if it is determined that whether the storage unit stores such processing subject information, outputs the processing subject identification information to the display unit.

5. The information processing apparatus according to claim 1, wherein
the input unit
can further accept input of execution information instructing execution of processing on content data selected by the selection information or content data identified by content identification information, further comprising:
an execution control unit that, when the input unit accepts input of execution information, causes the processing subject identified by the processing subject identification information acquired from the associated information stored in the storage unit to perform processing on the content data.

6. The information processing apparatus according to claim 5, wherein
the execution control unit
if, when processing on the content data corresponds to storage of program content data, the input unit accepts input of execution information and if it is determined that the processing subject identified by the processing subject identification information acquired from the associated information stored in the storage unit is a mobile device, inspects a state of the mobile device to determine whether the state information obtained by the inspection indicates a state that allows storage of the program content data in the mobile device and if it is determined that the state information indicates a state that does not allow storage of the program content data in the mobile device, causes the storage unit to store the program content data by temporarily putting storage of the program content data by the mobile device on hold and reinspects the state of the mobile device to determine whether the state information obtained by the inspection indicates a state that allows storage of the program content data in the mobile device and if it is determined that the state information indicates a state that allows storage of the program content data in the mobile device, transfers the program content data stored in the storage unit to the mobile device to be stored therein.

7. An information processing method, wherein
a display control unit of an information processing apparatus having a storage unit that stores at least one piece of associated information in which content data or content identification information and processing subject identification information used for identification of a processing subject, which is a device or an application enabled to perform processing on the content data, are associated, an input unit capable of accepting input of selection information to select the content data or the content identification information, and the display control unit executes a step of:
when the input unit accepts input of selection information, acquiring processing subject identification information associated with content data or content identification information selected by the selection information from the associated information stored in the storage unit and outputting the processing subject identification information to a display unit.

8. An information processing apparatus, comprising:
storage means for storing at least one piece of associated information with which content data or content identification information and processing subject identification information used for identification of a processing subject, which is a device or an application enabled to perform processing on the content data, are associated;
input means for enabling to accept input of selection information to select the content data or the content identification information; and
display control means that, when the input means accept input of selection information, acquire processing subject identification information associated with content data or content identification information selected by the selection information from the associated information stored in the storage unit and output the processing subject identification information to display means.
